(19) United States
(12) Patent Application Publication
(10) Pub. No.: US 2013/0005192 A1
(43) Pub. Date: Jan. 3, 2013

(54) BOARD-TO-BOARD CONNECTOR

(75) Inventor: Chin Hua Lim, Singapore (SG)

(73) Assignee: 3M Innovative Properties Company

(21) Appl. No.: 13/579,622

(22) PCT Filed: Feb. 22, 2011
(86) PCT No.: PCT/US2011/025640

§ 371 Date: Aug. 17, 2012

(30) Foreign Application Priority Data
Mar. 22, 2010 (SG) 201001957-8

(51) Int. Cl. H01R 24/28

(52) U.S. Cl. 439/660

(57) ABSTRACT

A plug connector comprising an insulative housing comprising an insulative longitudinal base with an insulative wall having a first face and a second face, the insulative wall extending from the longitudinal base and separating the longitudinal base into a first portion and a second portion, a first group and a second group of first passageways, a set of second passageways configured alongside the first passageways wherein each second passageway has a first segment extending from the first face of the insulative wall to the first portion of the longitudinal base and a second segment extending from the second face of the insulative wall to the second portion of the longitudinal base and a third segment connecting the first segment to the second segment and a plurality of signal contacts disposed in the first passageways.

### TECHNICAL FIELD

The present invention relates to board-to-board connectors, and more particularly to shielded electrical board-to-board connectors.

### BACKGROUND

An electrical board-to-board interconnect system generally includes a pair of plug and socket connectors each mounted on a printed circuit board (PCB) and both adapted to mate with each other mechanically and electrically. Conventional board-to-board interconnect systems are generally used in low-speed electrical transmission environments where signal noise and electromagnetic interference (EMI) are not very critical. Thus, the conventional systems generally have no specific shielding or grounding contacts for removing noise and EMI.

With the demand on higher speed electrical transmission as well as the miniaturization of electronic devices resulting in the reduction in size of the electrical connectors used, the conventional board-to-board interconnect systems need to be modified.

An example of such a modified interconnect system is disclosed in U.S. Pat. No. 5,915,976. Shields of a plug connector are attached on side walls of a housing of the plug connector and are selectively connected to some contacts of the plug connector. Each shield has an engagement arm. Correspondingly, a number of grounding contacts are disposed in a housing of the socket connector. The grounding contacts engage the engagement arm of the shields and connect with corresponding contacts of the socket connector. Thus, EMI and noise are dissipated to ground through the shields and the grounding contacts.

However, since the shields are attached on outer sides of side walls of the housing of the plug connector and since the grounding contacts are inserted into the engagement arms of the shields, the shields are prone to separate from the side walls of the housing of the plug connector when the plug and socket connectors are mated with each other. This is due to pushing force of the grounding contacts acting on the engagement arms of the shields. When such separation occurs, the grounding connections between the shields and the grounding contacts are rendered useless.

The present invention is directed to a plug and a socket connector with minimized cross-talk and good EMI shielding.

### SUMMARY

It would be desirable to provide a plug connector and a socket connector with minimized cross-talk and good EMI shielding.

In accordance with one embodiment of the present invention, there is provided a plug connector comprising an insulative housing comprising an insulative longitudinal base with an insulative wall having a first face and a second face, the insulative wall extending from the longitudinal base and separating the longitudinal base into a first portion and a second portion; a first group and a second group of first passageways wherein the first group of the first passageways extends from the first face of the insulative wall to the first portion of the longitudinal base and the second group of the first passageways extends from the second face of the insulative wall to the second portion of the longitudinal base; a set of second passageways configured alongside the first passageways wherein each second passageway has a first segment extending from the first face of the insulative wall to the first portion of the longitudinal base and a second segment extending from the second face of the insulative wall to the second portion of the longitudinal base and a third segment connecting the first segment to the second segment; and a plurality of signal contacts disposed in the first passageways wherein each signal contact comprises a mating portion, a terminal portion and an engaging portion connecting the mating portion to the terminal portion.

In accordance with another embodiment of the present invention, there is provided a socket connector comprising an insulative housing with a recess defined by a pair of side walls, each side wall having an inner face and an outer face, a first end wall and a second end wall; a plurality of signal passageways defined on the inner faces of the side walls; a plurality of signal contacts disposed in the signal passageways; a plurality of retention devices on at least one end wall of the insulative housing configured to cooperate with a plurality of complementary retention devices on an optional supplementary shield plate; and a first housing extension configured in proximity to a first end of the side wall and a second housing extension configured in proximity to a second end of the side wall, both first and second housing extensions configured to cooperate with the optional supplementary shield plate and retain the optional supplementary shield plate to the insulative housing when the optional supplementary shield plate is coupled to the socket connector.

The invention further includes any alternative combination of parts or features mentioned herein or shown in the accompanying drawings. Known equivalents of these parts or features which are not expressly set out are nevertheless deemed to be included.

### BRIEF DESCRIPTION OF THE DRAWINGS

An exemplary form of the present invention will now be described with reference to the accompanying drawings in which:

FIG. 1 is a perspective view of an exemplary plug connector and an exemplary socket connector forming the interconnect system in accordance with one embodiment of the invention;

FIG. 2 is an exploded, perspective view of the plug connector in FIG. 1;

FIG. 3 is an exploded, perspective view of the socket connector in 10 FIG. 1;

FIG. 4 is a cross-sectional view of the plug connector and the socket connector in FIG. 1 in a mid-way mating position taken at a location where a set of signal contacts is located;

FIG. 5 is a cross-sectional view of the plug connector and the socket connector in FIG. 1 in a mid-way mating position taken at a location where a grounding contact is located;

FIG. 6 is a perspective view of an arrangement of a set of signal contacts, a set of grounding contacts and a plurality of shield plates in accordance with another embodiment of the invention;

FIG. 7 is a sectional view of the socket connector in FIG. 1 with a complementary retention device on an optional supplementary shield plate coupled to a retention device on the socket connector;

FIG. 8 is a perspective view of a socket connector in accordance with another embodiment of the invention; and

FIG. 9 is a perspective view of the plug connector and the socket connector in FIG. 1 in a mid-way mating position taken from one end of the interconnect system.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

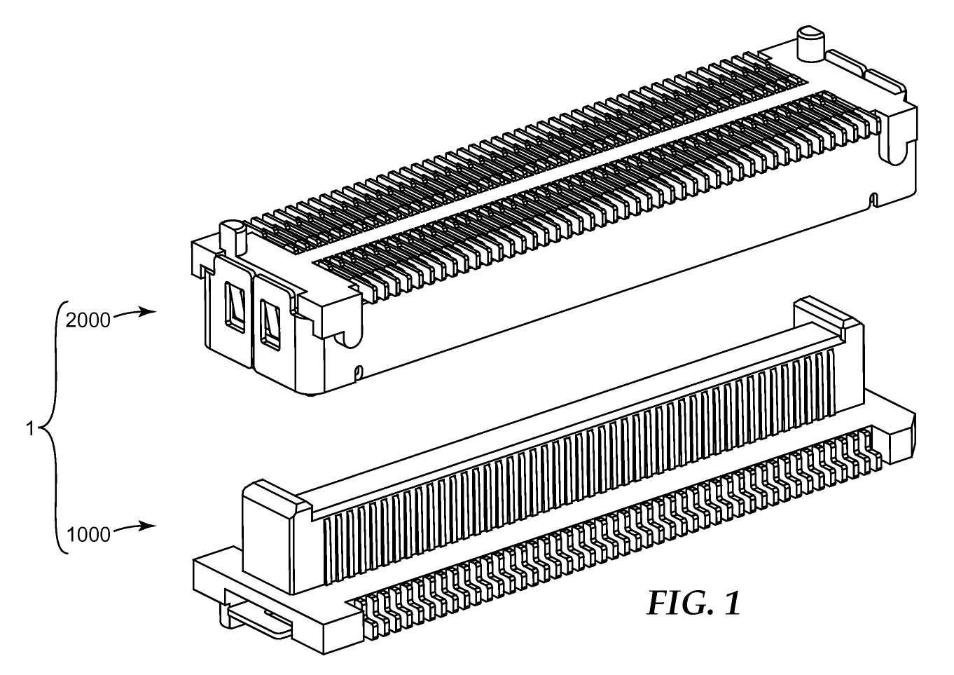

Referring to FIG. 1, an electrical board-to-board interconnect system 1 in accordance to an embodiment of the present invention comprises a plug connector 1000 and a socket connector 2000.

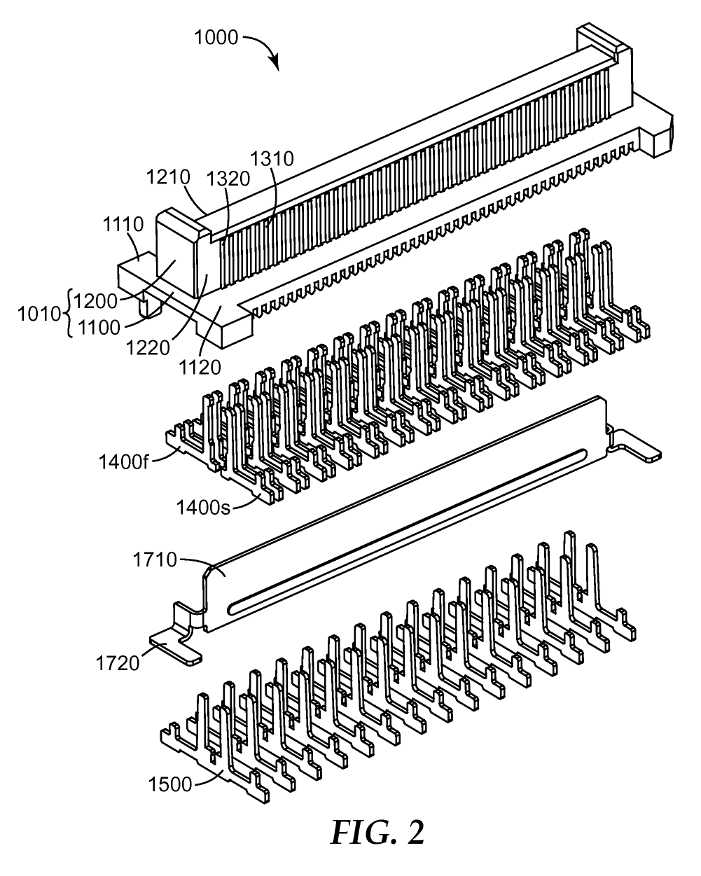

FIG. 2 provides an exploded view of the exemplary plug connector 1000 shown in FIG. 1. The plug connector 1000 comprises an insulative housing 1010 comprising an insulative longitudinal base 1100 with an insulative wall 1200 having a first face 1210 and a second face 1220. In one embodiment, the insulative wall 1200 extends from the longitudinal base 1100 thereby separating the longitudinal base 1100 into a first portion 1110 and a second portion 1120.

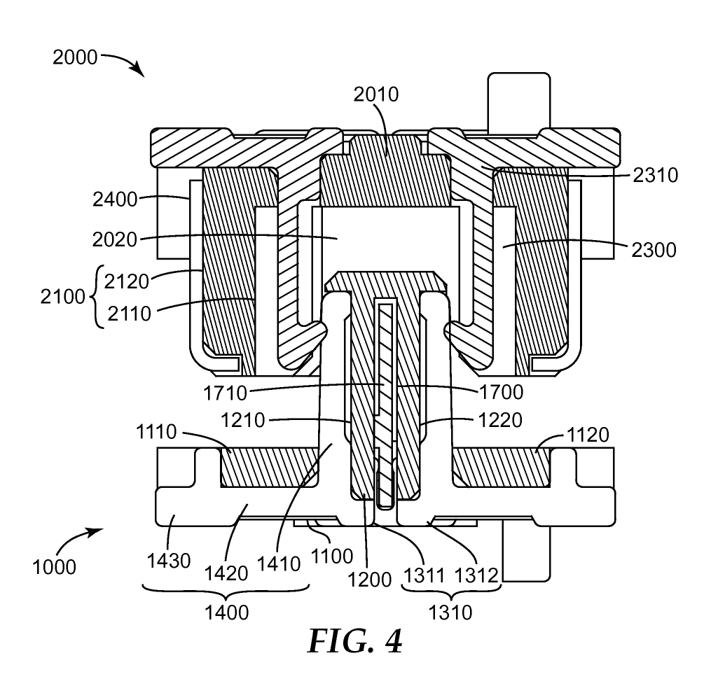

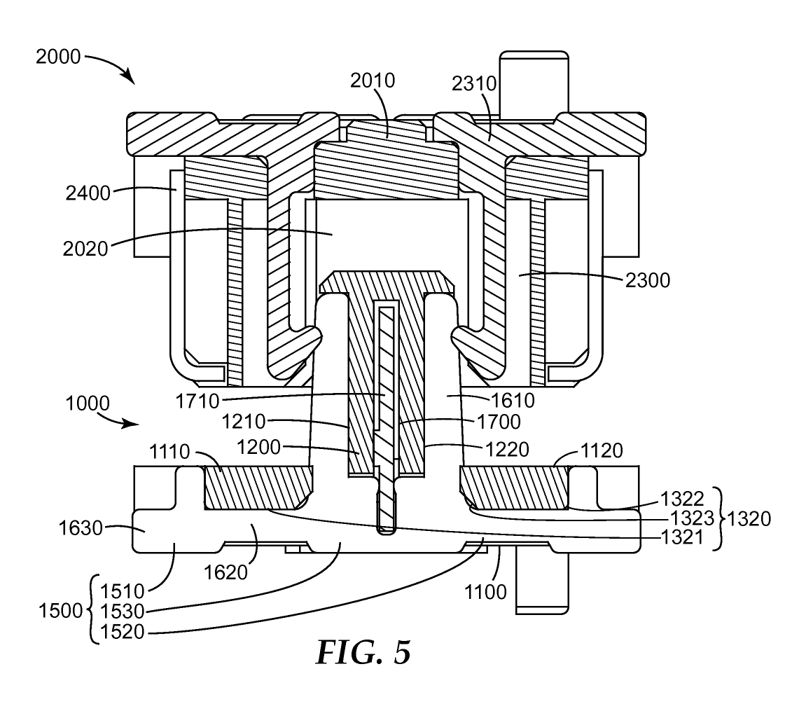

The plug connector 1000 further comprises a set of first passageways 1310 and a set of second passageways 1320. Referring also to FIG. 4 and FIG. 5, in one embodiment of the present invention, the set of first passageways 1310 is divided into a first group 1311 and a second group 1312 wherein the first group 1311 of the first passageways 1310 extends from the first face 1210 of the insulative wall 1200 to the first portion 1110 of the longitudinal base 1100 and the second group 1312 of the first passageways 1310 extends from the second face 1220 of the insulative wall 1200 to the second portion 1120 of the longitudinal base 1100.

In one embodiment of the present invention, the set of second passageways 1320 is configured alongside the first passageways 1310 with each second passageway 1320 having a first segment 1321 extending from the first face 1210 of the insulative wall 1200 to the first portion 1110 of the longitudinal base 1100, a second segment 1322 extending from the second face 1220 of the 25 insulative wall 1200 to the second portion 1120 of the longitudinal base 1100 and a third segment 1323 connecting the first segment 1321 to the second segment 1322.

In one embodiment of the present invention, there is a signal contact 1400 disposed in each first passageway 1310 and there is a grounding contact 1500 disposed in each second passageway 1320. Each signal contact 1400 comprises a mating portion 1410, a terminal portion 1430 and an engaging portion 1420 connecting the mating portion 1410 to the terminal portion 1430. Each grounding contact 1500 comprises a first arm 1510, a second arm 1520 and a contact body 1530, wherein the first arm 1510 is disposed in the first segment 1321 of the second passageway 1320, the second arm 1520 is disposed in the second segment 1322 of the second passageway 1320 and the contact body 1530 is disposed in the third segment 1323 of the second passageway 1320. Both the first arm 1510 and the second arm 1520 of the grounding contact 1500 each has a mating portion 1610, a terminal portion 1630 and an engaging portion 1620 connecting the mating portion 1610 to the terminal portion 1630.

In one embodiment of the present invention, the insulative wall 1200 further comprises a longitudinal passageway 1700 extending from one end of the insulative wall 1200 to an opposite end of the insulative wall 1200. In another embodiment of the present invention, the plug connector 1000 further comprises a shield plate 1710 disposed in the longitudinal passageway 1700. The shield plate 1710 may further include a plurality of terminal legs 1720 configured on at 20 least one end of the shield plate 1710.

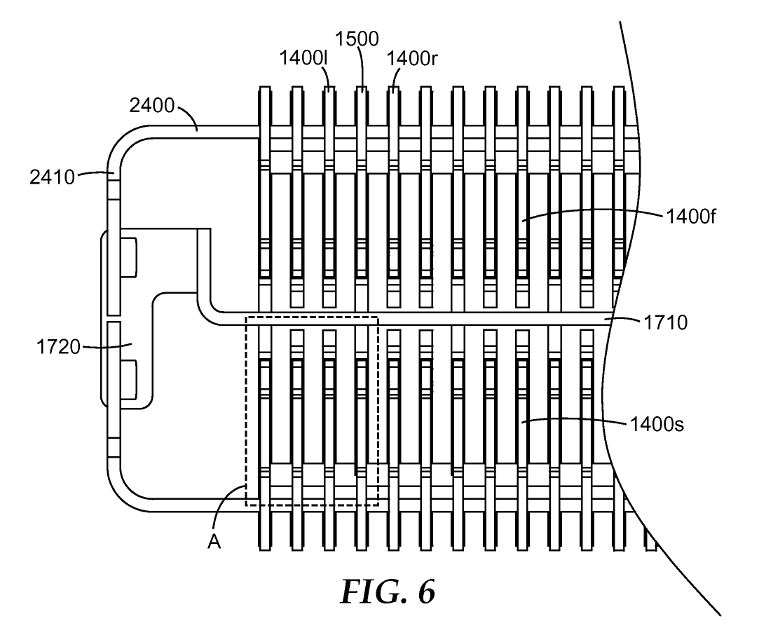

With reference to FIG. 6, when the terminal portion 1630 (not shown) of the grounding contact 1500 is connected to a grounding trace (not shown) of a printed circuit board (PCB) on which the plug connector 1000 is to be connected to, the grounding contact 1500 will minimize the cross-talk between a left signal contact 1400l disposed on one side of the grounding contact 1500 and a right signal contact 1400r disposed on the other side of the grounding contact 1500.

When the terminal legs 1720 of the shield plate 1710 is connected to a grounding trace (not shown) of a printed circuit board (PCB) on which the plug connector 1000 is to be connected to, the shield plate 1710 will minimize the cross-talk between the signal contacts 1400f disposed in the first group 1311 of the first passageway 1310 and the signal contacts 1400s disposed in the second group 1312 of the first passageway 1310.

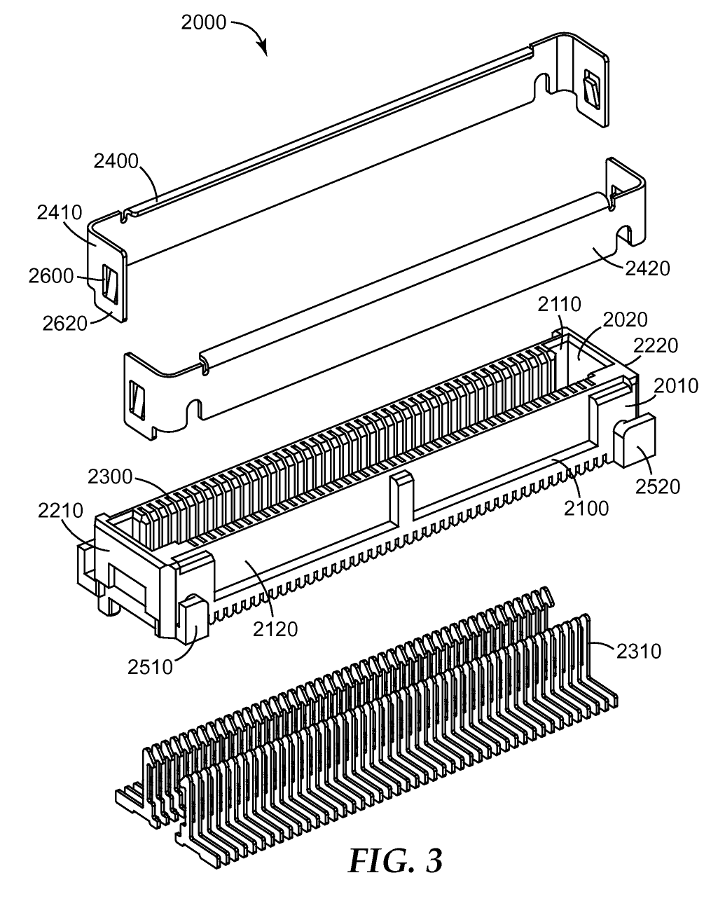

FIG. 3 provides an exploded view of the exemplary socket connector 2000 shown in FIG. 1. The plug connector 2000 comprises an insulative housing 2010 with a recess 2020 defined by a pair of side walls 2100 wherein each side wall has an inner face 2110 and an outer face 2120, a first end wall 2210 and a second end wall 2220, a first housing extension 2510 configured in 10 proximity to a first end of the side wall and a second housing extension 2520 configured in proximity to a second end of the side wall, a plurality of signal passageways 2300 defined on the inner faces 2110 of the side walls 2100, and a plurality of signal contacts 2310 disposed in the signal passageways 2300.

In one embodiment of the present invention, the socket connector 2000 further comprises a plurality of retention devices 2320 on at least one end wall of the insulative housing 2010 configured to cooperate with a plurality of complementary retention devices 2600 on an optional supplementary shield plate 2400. The optional supplementary shield plate 2400 provides additional EMI shielding from the external environment. Thus, for applications where it is not critical to provide good EMI shielding from the external environment, the socket connector 2000 may not require the optional supplementary shield plate 2400.

In one embodiment of the present invention, the socket connector 2000 is coupled with at least one supplementary shield plate 2400 comprising at least one terminal leg 2620 and at least one end finger 2410 connected to a longitudinal shield body 2420 extending from the first housing extension 2510 to the second housing extension 2520 wherein the end finger 2410 is configured with a plurality of complementary retention devices 2600. The first housing extension 2510, the second housing extension 2520 and together with the complementary retention devices 2600 on the end finger 2410 of the supplementary shield plate 2400 which are designed to cooperate with the retention devices 2320 on the end wall of the insulative housing 2010, retain the supplementary shield plate 2400 to the insulative housing 2010 when the supplementary shield plate 2400 is coupled to the socket connector 2000.

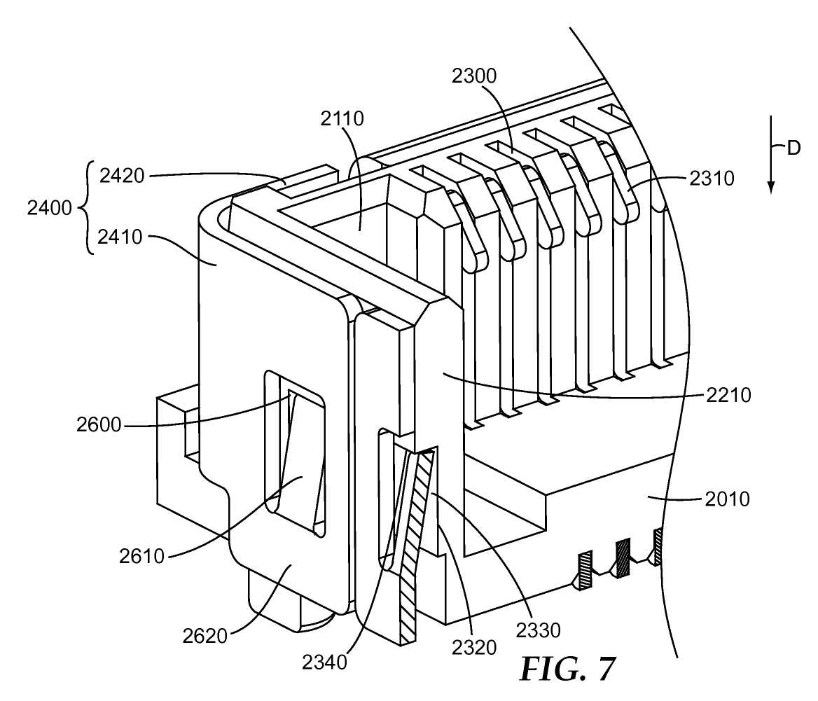

With reference to FIG. 7, in one embodiment of the present invention, the retention device 2320 configured at the end wall of the insulative housing 2010 may be but not limited to, a groove 2330 extending inwardly into the end wall and the complementary retention device 2600 on the supplementary shield plate 2400 may be but not limited to, a latch 2610 extending away from the end finger 2410 towards the end wall of the insulative housing 2010.

To couple the supplementary shield plate 2400 with the socket connector 2000, the supplementary shield plate 2400 is to be fitted from the top of the socket connector 2000. As the supplementary shield plate 2400 moves vertically down towards the socket connector 2000 (as shown by the arrow D), the end wall of the insulative housing 2010 deflects the latch 2610 on the supplementary shield plate 2400 towards the end finger 2410 as the latch 2610 traverse the end wall. As soon as the latch 2610 passes an edge 2340 before the groove 2330, the latch 2610 immediately returns to its original position and thus engaging with the groove 2330 in the end wall. The supplementary shield plate 2400 is now coupled and retained to the socket connector 2000 and the supplementary shield plate 2400 will not be accidentally dislodged from the socket connector 2000.

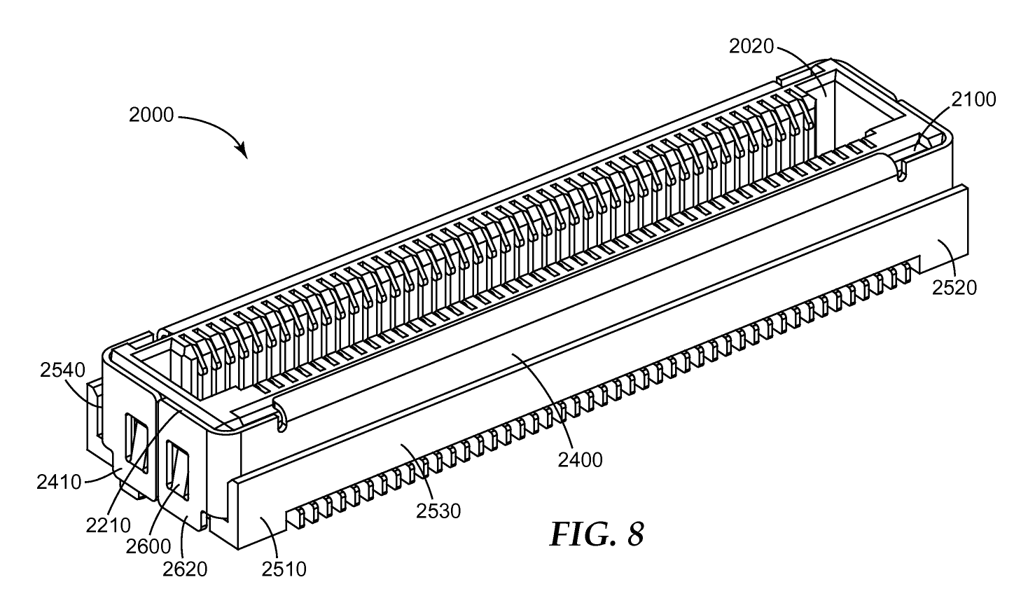

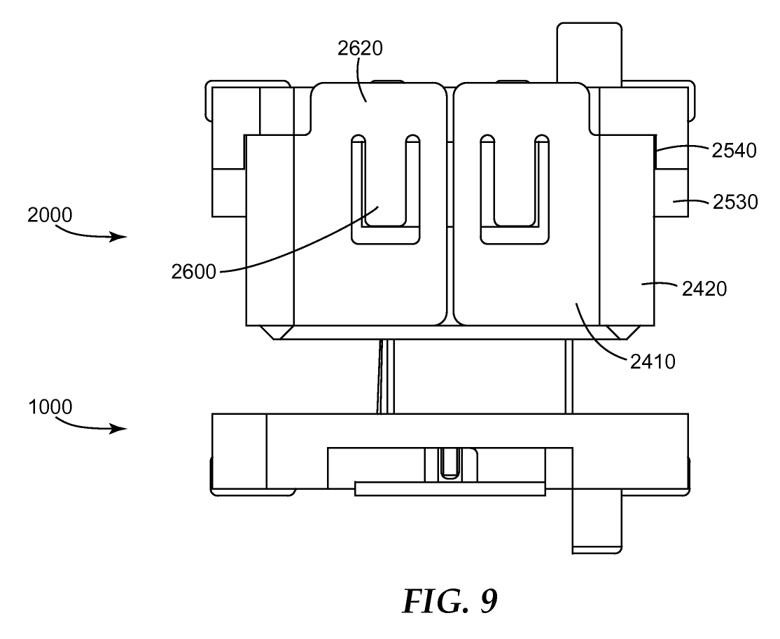

With reference to FIG. 8 and FIG. 9, in one embodiment of the present invention, the socket connector 2000 further comprises a housing ledge 2530 adjoining the first housing extension 2510 to the second housing extension 2520 thereby defining a corridor 2540 between the side wall 2100 of the insulative housing 2010 and the housing ledge 2530. In another embodiment of the present invention, the housing ledge 2530 at least partially covers an optional supplementary shield plate 2400 when the optional supplementary shield plate 2400 is coupled to the socket connector 2000. The housing ledge 2530 serves to further retain the optional supplementary shield plate 2400 to the socket connector 2000 and prevents the optional supplementary shield plate 2400 from being damaged by any 5 external forces.

When the terminal legs 2620 of the optional supplementary shield plate 2400 is connected to a grounding trace (not shown) of a printed circuit board (PCB) on which the socket connector 2000 is to be connected to, the optional supplementary shield plate 2400 will provide EMI shielding from the external 10 environment for the socket connector 2000.

The combination of the grounding contacts 1500 disposed alongside with the signal contacts 1400, the shield plate 1710 disposed in the longitudinal passageway 1700 of the plug connector 1000 and the coupling of the optional supplementary shield plate 2400 to the socket connector 2000 confine each set of 15 signals within a designated area A as shown in FIG. 6. It is therefore clear how the board-to-board interconnect system 1 is able to reduce the cross-talk between the signal contacts and lower the EMI shielding from the external environment when the plug connector 1000 is coupled to the socket connector 2000.

Item 1 is a plug connector comprising an insulative housing comprising:

an insulative longitudinal base with an insulative wall having a first face and a second face, the insulative wall extending from the longitudinal base and separating the longitudinal base into a first portion and a second portion;

a first group and a second group of first passageways wherein the first group of the first passageways extends from the first face of the insulative wall to the first portion of the longitudinal base and the second group of the first passageways extends from the second face of the insulative wall to the second portion of the longitudinal base;

a set of second passageways configured alongside the first passageways wherein each second passageway has a first segment extending from the first face of the insulative wall to the first portion of the longitudinal base and a second segment extending from the second face of the insulative wall to the second portion of the longitudinal base and a third segment connecting the first segment to the second segment; and

a plurality of signal contacts disposed in the first passageways wherein each signal contact comprises a mating portion, a terminal portion and an engaging portion connecting the mating portion to the terminal portion.

Item 2 is the plug connector of item 1 further comprising a plurality of grounding contacts disposed in the second passageways, each grounding contact comprising a first arm, a second arm and a contact body, wherein the first arm is disposed in the first segment of the second passageway, the second arm is disposed in the second segment of the second passageway and the contact body is disposed in the third segment of the second passageway.

Item 3 is the plug connector of item 2 wherein both the first arm and the second arm of the grounding contact each comprise a mating portion, a terminal portion and an engaging portion connecting the mating portion to the terminal portion.

Item 4 is the plug connector of one of the preceding items 1 to 3 wherein the insulative wall further comprise a longitudinal passageway extending from one end of the insulative wall to an opposite end of the insulative wall.

Item 5 is the plug connector of item 4 further comprising a shield plate disposed in the longitudinal passageway.

Item 6 is the plug connector of item 5 further comprising a plurality of terminal legs configured on at least one end of the shield plate.

Item 7 is a socket connector comprising:

an insulative housing with a recess defined by a pair of side walls, each side wall having an inner face and an outer face, a first end wall and a second end wall;

a plurality of signal passageways defined on the inner faces of the side walls;

a plurality of signal contacts disposed in the signal passageways;

a plurality of retention devices on at least one end wall of the insulative housing configured to cooperate with a plurality of complementary retention devices on an optional supplementary shield plate; and

a first housing extension configured in proximity to a first end of the side wall and a second housing extension configured in proximity to a second end of the side wall, both first and second housing extensions configured to cooperate with the optional supplementary shield plate and retain the optional supplementary shield plate to the insulative housing when the optional supplementary shield plate is coupled to the socket connector.

Item 8 is the socket connector of item 7 further comprising a housing ledge adjoining the first housing extension to the second housing extension thereby defining a corridor between the side wall of the insulative housing and the housing ledge such that the housing ledge at least partially covers an optional supplementary shield plate when the optional supplementary shield plate is coupled to the socket connector.

Item 9 is the socket connector of item 7 or item 8 further comprising at least one supplementary shield plate comprising at least one terminal leg and at least one end finger connected to a longitudinal shield body extending from the first housing extension to the second housing extension wherein the end finger is configured with a plurality of complementary retention devices designed to cooperate with the retention devices on the end wall of the insulative housing and retain the supplementary shield plate to the insulative housing when the supplementary shield plate is coupled to the socket connector.

Item 10 is the socket connector of item 9 wherein the retention device configured at the end wall of the insulative housing is a groove extending inwardly into the end wall and the complementary retention device on the supplementary shield plate is a latch extending away from the end finger towards the end wall of the insulative housing such that the latch engages the groove and retain the supplementary shield plate to the insulative housing when the supplementary shield plate is coupled to the socket connector.

Item 11 is a board-to-board interconnect system comprising:

a plug connector of any one of the items 1 to 6; and

a socket connector of any one of the items 7 to 10.

The foregoing description of the preferred embodiment of the invention has been presented for purposes of illustration and description. It is not intended to be exhaustive or to limit the invention to the precise forms disclosed, since many modifications or variations thereof are possible in light of the above teaching. All such modifications and variations are within the scope of the invention. The embodiments described herein were chosen and described in order to best explain the principles of the invention and its practical application, thereby to enable others skilled in the art to utilize the invention in various embodiments and with various modifications as are suited to the particular use contemplated thereof. It is intended that the scope of the invention be defined by the claims appended hereto, when interpreted in accordance with the full breadth to which they are legally and equitably suited.

1. A plug connector comprising an insulative housing comprising:
an insulative longitudinal base with an insulative wall having a first face and a second face, the insulative wall extending from the longitudinal base and separating the longitudinal base into a first portion and a second portion;
a first group and a second group of first passageways wherein the first group of the first passageways extends from the first face of the insulative wall to the first portion of the longitudinal base and the second group of the first passageways extends from the second face of the insulative wall to the second portion of the longitudinal base;
a set of second passageways configured alongside the first passageways wherein each second passageway has a first segment extending from the first face of the insulative wall to the first portion of the longitudinal base and a second segment extending from the second face of the insulative wall to the second portion of the longitudinal base and a third segment connecting the first segment to the second segment; and
a plurality of signal contacts disposed in the first passageways wherein each signal contact comprises a mating portion, a terminal portion and an engaging portion connecting the mating portion to the terminal portion.

2. The plug connector of claim 1 further comprising a plurality of grounding contacts disposed in the second passageways, each grounding contact comprising a first arm, a second arm and a contact body, wherein the first arm is disposed in the first segment of the second passageway, the second arm is disposed in the second segment of the second passageway and the contact body is disposed in the third segment of the second passageway.

3. The plug connector of claim 2 wherein both the first arm and the second arm of the grounding contact each comprise a mating portion, a terminal portion and an engaging portion connecting the mating portion to the terminal portion.

4. The plug connector of one of the preceding claims 1 to 3 wherein the insulative wall further comprise a longitudinal passageway extending from one end of the insulative wall to an opposite end of the insulative wall.

5. The plug connector of claim 4 further comprising a shield plate disposed in the longitudinal passageway.

6. The plug connector of claim 5 further comprising a plurality of terminal legs configured on at least one end of the shield plate.

7. A socket connector comprising:
an insulative housing with a recess defined by a pair of side walls, each side wall having an inner face and an outer face, a first end wall and a second end wall;
a plurality of signal passageways defined on the inner faces of the side walls;
a plurality of signal contacts disposed in the signal passageways;
a plurality of retention devices on at least one end wall of the insulative housing configured to cooperate with a plurality of complementary retention devices on an optional supplementary shield plate; and
a first housing extension configured in proximity to a first end of the side wall and a second housing extension configured in proximity to a second end of the side wall, both first and second housing extensions configured to cooperate with the optional supplementary shield plate and retain the optional supplementary shield plate to the insulative housing when the optional supplementary shield plate is coupled to the socket connector.

8. The socket connector of claim 7 further comprising a housing ledge adjoining the first housing extension to the second housing extension thereby defining a corridor between the side wall of the insulative housing and the housing ledge such that the housing ledge at least partially covers an optional supplementary shield plate when the optional supplementary shield plate is coupled to the socket connector.

9. The socket connector of claim 7 or claim 8 further comprising at least one supplementary shield plate comprising at least one terminal leg and at least one end finger connected to a longitudinal shield body extending from the first housing extension to the second housing extension wherein the end finger is configured with a plurality of complementary retention devices designed to cooperate with the retention devices on the end wall of the insulative housing and retain the supplementary shield plate to the insulative housing when the supplementary shield plate is coupled to the socket connector.

10. The socket connector of claim 9 wherein the retention device configured at the end wall of the insulative housing is a groove extending inwardly into the end wall and the complementary retention device on the supplementary shield plate is a latch extending away from the end finger towards the end wall of the insulative housing such that the latch engages the groove and retain the supplementary shield plate to the insulative housing when the supplementary shield plate is coupled to the socket connector.

11. A board-to-board interconnect system comprising:
a plug connector of any one of the claims 1 to 6; and
a socket connector of any one of the claims 7 to 10.
